(19) United States
(12) Patent Application Publication
(10) Pub. No.: US 2013/0270094 A1
(43) Pub. Date: Oct. 17, 2013

(54) OPERATOR CONTROL DEVICE AND OPERATING METHOD

(71) Applicants: Wolfgang Hamm, Bretten (DE); Martin Baier, Ettlingen (DE)

(72) Inventors: Wolfgang Hamm, Bretten (DE); Martin Baier, Ettlingen (DE)

(73) Assignee: E.G.O. ELEKTRO-GERAETEBAU GmbH, Oberderdingen (DE)

(21) Appl. No.: 13/877,888

(22) PCT Filed: Oct. 5, 2011
(86) PCT No.: PCT/EP2011/067398

§ 371 Date: Jun. 12, 2013

(30) Foreign Application Priority Data
Oct. 6, 2010 (DE) 10 2010 048 081.9

(51) Int. Cl. H01H 25/06

(52) U.S. Cl. CPC H01H 25/065
USPC 200/566

(57) ABSTRACT

An operator control device for functional adjustment of a functional device includes an operator control knob which has an off position in which the operator control device is deactivated. Said knob can be brought into a working position for functional adjustment purposes. The working position is predetermined by a lock-in position, and, starting from the working position, the operator control knob can be pulled out of the operator control device or pressed into the operator control device against a counterforce which increases as the distance from the working position increases. Here, the operator control device includes a movement detection means for detecting movement of the operator control knob out of the working position in one direction or in the other direction. The movement detection means is connected to a controller of the operator control device so as to carry out functional adjustment in a manner dependent on the detected movement.

### CROSS REFERENCE TO RELATED APPLICATIONS

This application is a National Stage application, filed under 35 U.S.C. §371, of International Application PCT/EP2011/067398, filed Oct. 5, 2011, which claims priority to German Application No. 10 2010 048 081.9, filed Oct. 6, 2010, both of which are hereby incorporated by reference in their entirety.

### TECHNOLOGICAL FIELD

The invention relates to an operator control device and an operating method for functional adjustment of a functional device, in particular for functional adjustment or adjustment of power or capacity in a heating device of a cooktop or the like. The operator control device comprises an operator control knob and is configured such that the operator control knob has or assumes an off position, in which it is deactivated. Therefrom it can be brought into a working position for the abovementioned functional adjustment.

### BACKGROUND

A similar operator control device is known from DE 10 2010 039 415 filed by the same applicant. Said device comprises a rotary knob which can be turned into a working position from an off position. Then, there is a lock-in position out of which the rotary knob can be turned in both directions for functional adjustment against an increasing resistance. However, said operator control device can exclusively be used for an operator control concept based on turning.

### BRIEF SUMMARY

The object underlying the invention is to provide an aforementioned operator control device as well as an operating method that can be conducted therewith, by means of which problems of the prior art can be eliminated, and in particular a practicable operator control device can be provided with a comfortable operating method.

The object is achieved by an operator control device as well as by an operating method. Advantageous as well as preferred embodiments of the invention are indicated in the further claims and will be explained in more detail in the following. In this case, some of the features are only explained in the context of the operator control device or the operating method. However, regardless of this, they should be applicable to both the operator control device and the operating method. The wording of the claims is incorporated in the content of the description by explicit reference.

Provision is made for that the working position of the operator control device or the operator control knob, respectively, is predefined by lock-in positions or arrestors or the like. Starting from said working position, the control knob can be pulled out or pushed in against a counter force which increases with increasing distance from the working position. Namely, this means that the counter force increases the further the operator control knob is pulled out or pushed in relative to a displacement or movement path. The operator control device comprises a movement detection means, in order to detect, if and how the operator control knob is moved into one direction or into the other direction from the working position. Said movement detection means is connected to a control unit of the operator control device in order to allow the functional adjustment in response to the detected movement or also the time characteristics of the movement.

Thus, by means of the invention, it is possible to provide an operator control device operative to allow an operator control knob to be pulled out or pushed in instead of a rotary operation control, for example in order to increase or reduce the heating capacity of a heating device of a cooktop. In some aspects, a more intuitive operation control is offered thereby. Furthermore, it is possible to arrange multiple operator control knobs closer together since free space for fingers grabbing the knob required around said knobs for turning is not necessary.

In an advantageous embodiment of the invention, the control unit is configured such that upon a further movement the functional adjustment is effected more rapidly or changes more rapidly. This means that the functional adjustment is indeed effected the more rapid the further the operator control knob is moved away from the working position in one direction. Thus, a very slow or sensitive and exact functional adjustment can be effected by minor movement. By means of a stronger or more rapid moving and a longer path covered, a very rapid adjustment can be effected, for example in order to rapidly achieve a certain level. Said movement covering a longer path can easily be detected and evaluated by the movement detection means.

In an alternative embodiment of the invention, it is possible that the operator control knob is pulled out or pushed repeatedly in the same manner. This is in each case effected by means of a small or slight movement in the same direction, which thus corresponds to some type of toggling, as known for rotary knobs. The number of the similar movements can be detected therein, likewise their temporal progression, and a function can result therefrom, for example an aforementioned power or capacity adjustment. Such short movements are advantageously effected from an unstable intermediate position of the operator control device. The operator control knob is brought into said intermediate position and is then moved repeatedly into the same direction by further application of force.

In an advantageous further embodiment of the invention, the operator control knob can in each case be pushed in or pulled out of the operator control device from the working position against a counter force. On the one hand, said counter force effects an automatic or self-acting return of the operator control knob to the working position upon releasing the knob. Furthermore, the haptic feeling during operation control is improved by said counter force. By means of a possible increasing counter force, there is, so to say, a haptic mediation that the adjusted function is actually influenced increasingly more thereby.

A counter force device by means of which the aforementioned counter force can be generated, can comprise at least one spring, advantageously two springs for each direction of movement. Such a spring can be applied with an increasing force upon increasing movement away from the working position, in order to actually exert the increasing counter force. Thus, the operator control movement can directly compress the spring, in the case of a pressure spring, or extend it, in the case of an extension spring, in order to generate the increasing counter force. In one possible structural design of the operator control device it is possible that the at least one spring, advantageously both springs, is/are provided on one or each end/s of the operator control device along the direction of operation. In a particularly advantageous configuration, these are pressure springs.

A maximum movement path when pulling the operator control knob out of the operator control device or when pushing it in may advantageously be less than one centimeter. Preferably, it is approximately 5 mm. This is especially possible in case that not only the mere path covered by the operator control knob is used as a variable for a functional adjustment resulting therefrom, but additionally the duration thereof. Thus, functional operation can be altered depending on duration, and advantageously in the adjustment of a capacity value, namely the more rapidly the further the operator control knob is pulled out or pushed in, for example. Thereby, very short operation control paths can be provided which allow a desired rapid and sensitive operation control.

In a further embodiment of the invention, a counter force device for generating the counter force can be configured according to the cam principle including a protruding cam part extending transversely in relation to the movement direction. Said device can be provided in addition to the aforementioned one or two springs. The cam part abuts on a slider shifting link at least within the working movement region, which shifting link is provided for a haptic feeling and the counter force during operation control. The slider shifting link extends in both movement directions from the working position and essentially consists of a depression, the deepest point of which forms the working position. Thus, when the cam part contacts the slider shifting link at the deepest point, a quasi-stable intermediate location is generated as a working position, in which, however, operation control is not yet detected nor performed. The cam part is configured such that it can be pushed in by means of a spring load transversely to the movement direction of the operator control knob and thus is spring loaded to abut the slider shifting link. If the operator control knob is pushed in or pulled out, the slider shifting link preferably attached to it moves past the cam part and presses the cam part back against the aforementioned spring force by means of a rising lateral slider shifting link wall. Thereby, the counter force acting against the operation control movement can be generated on its own or in addition.

In this case, the cam part is preferably configured to be stationary or not movable along the movement direction of the operator control knob during operation control, i.e. to be stationary in the pulling direction and in the pushing direction. It is movable merely transversely in relation thereto or thus linearly slidable. The slider shifting link can preferably be configured symmetrically to a line along the movement direction of the cam part towards the slider shifting link, so that the resulting counter force is identical during both pushing in and pulling out of the operator control knob. However, it is also conceivable to provide different shapes for the slider shifting link to allow one operation control movement to be effected more easily than the other.

A counter force generated at the operator control knob can be in the range of maximum a few Newton centimeters (Ncm). Here, approximately one Ncm to three Ncm are considered to be advantageous.

For detection of a movement of the operator control knob, the movement detection means advantageously comprises two magnets provided successively in the movement direction. Furthermore, a magnet sensor is provided which is advantageously arranged between the two magnets. In fact, it is also possible to arrange the magnet sensor on the movable knob and the magnets stationary on the operation control device. However, since this requires an elaborate electric wiring, it is considered to be more advantageous to dispose the magnets on the operator control knob and the magnet sensor on the operation control device. In this case, they are advantageously disposed such that the magnet sensor is arranged on the working position and the two magnets somewhat spaced therefrom in both movement directions, i.e., on the hand, in the pushing in direction, and on the other hand, in the pulling out direction. Thus, upon slightly pushing in or pulling out the operator control knob, one of the two magnets approaches the magnet field sensor from one or the other side. This can be detected and evaluated as a corresponding movement. That way, a longer or further movement can also be detected by changing the magnetic field strength on the magnet sensor.

The operation control device can advantageously be configured for a turn-press actuation as an additional security means against unauthorized operation control. For instance, it can be provided that at first the operator control knob has to be turned out of the off position into the working position. Only in said working position it can be pulled out or pushed in for proper operation control. To that end, advantageously a guidance with a so-called cardioid curve can be provided on the operator control knob in which a driver of a surrounding housing of the operation control device engages. This is known to the persons skilled in the art and does not need to be explained in more detail.

Said features and further features arise, besides from the claims, also from the description and the drawings, wherein the individual features can be realized in each case on their own or in the form of sub-combinations of several thereof in an embodiment of the invention and in other fields, and can represent embodiments that are advantageous as well as patentable per se for which protection is claimed hereby. The division of the application into individual sections as well as cross headings does not limit the statements made thereunder in their general validity.

### BRIEF DESCRIPTION OF THE SEVERAL VIEWS OF THE DRAWINGS

Embodiments of the invention are schematically shown in the drawings and will be explained in more detail in the following. The figures show in:

FIG. 1 a side view from the exterior of an operation control device according to the invention,

FIG. 2 a plan view of the operation control device of FIG. 1,

FIG. 3 a section according to A-A through the operation control device of FIG. 2,

FIG. 4 an enlarged detail D of FIG. 3 having a cam part which abuts on a slider shifting link which is arranged on a movement part,

FIG. 5 a section C-C of FIG. 3,

FIG. 6 an exterior view in partially sectional illustration according to FIG. 1,

FIG. 7 a section B-B according to FIG. 2, located quasi behind the view of FIG. 7, and

FIG. 8 a schematic illustration with the operator control knob in the off position shown on the left and the working position shown on the right, from which the operator control knob can be pulled out and pushed in.

### DETAILED DESCRIPTION

Fig. I illustrates in a side view an operator control device 11 according to the invention, comprising a housing 12 where on top to the left and to the right are provided projecting fixing wings 13a and 13b. In general such features are well-known to a person skilled in the art. The operator control device 11 is disposed underneath a control panel 15, illustrated in dashed lines. The operator control device 11 protrudes through the control panel 15 via a rotary shaft 17 and an operator control knob 18 is attached on front by conventional ways and means, in this case particularly firm and most reliably secured against removal.

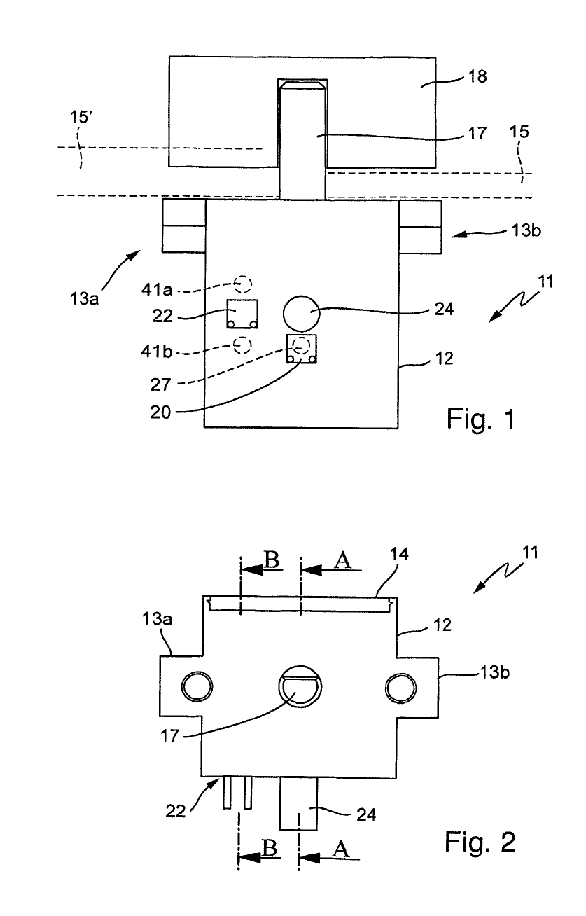

An alternative control panel 15′ is illustrated on the left side in FIG. 1. Therein the operator control knob 18 is countersunk to a certain length in an enlarged opening of the control panel 15′ in such a way that in the pulled-out condition, it does not project beyond the front face of the panel, as will be explained in more detail below. Thus, a slot or gap between the control panel 15 and the operator control knob 18, as visible on the right side in FIG. 1, may be omitted.

Furthermore, in the exterior view according to FIG. 1, a first magnet sensor 20 and a second magnet sensor 22 are shown, with their connectors oriented to the exterior, as also illustrated in the plan view of FIG. 2. The sensors are offset one from the other both in height and laterally. In the plan view of FIG. 2, the first magnet sensor 20 is covered by a shoulder 24, and thus is not visible.

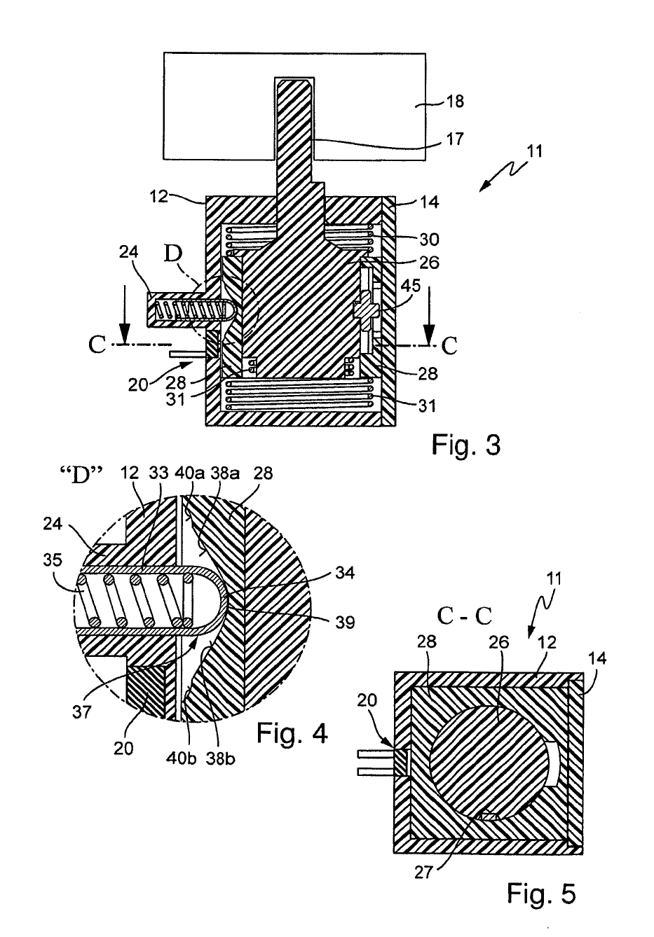

The plan view of FIG. 2 also shows that the housing 12 is produced essentially in one piece and integrally, what is also visible in the sectional view of FIGS. 3 and 5. Opposed to the shoulder 24 is a lateral cover 14 provided, on the one hand to allow access to the housing 12 and the interior thereof, respectively, and on the other hand for a closure.

FIG. 3 shows a sectional view A-A according to FIG. 2, namely the operator control device 11 according to FIG. 1, as seen from the right side. In the wall of the housing 12 the first magnet sensor 20 is mounted below the shoulder 24, advantageously according to FIG. 1 inserted and fixed from the exterior in a corresponding recess. Said first magnet sensor 20 is to detect an off position of the operator control device 11 or of the operator control knob 18, not shown in the drawings, as will be explained in more detail in the following.

In the lower region, the rotary shaft 17 passes integrally into a movement part 26. Said part is, as shown in FIG. 5 section C-C, circular cylindrical and may be rotating in a bearing part 28. The bearing part 28 is received non-rotatingly locked in the housing 12 due to its rectangular outer contour, while the movement part 26 may be rotating within the inner circular opening. However, the bearing part 28 can be moved in the longitudinal direction of the rotary shaft 17 within the housing 12. This will be explained in more detail below.

FIG. 5 also shows that a first signal magnet 27 is disposed in the movement part 26, for example by adhesive bonding or injection molding. Said magnet is located on the same rotation level as the first magnet sensor 20. In the off position as illustrated in FIG. 5, the first signal magnet 27 is turned by 90° counterclockwise relative to the first magnet sensor 20. Due to a turning of the operator control knob 18 and thus the movement part 26 by 90° clockwise, the signal magnet 27 is set in front of the magnet sensor 20, what can actually be detected and is a signaling that the working position is present or has been reached, as illustrated in the FIGS. 1 and 3 to 5.

As may be observed in the working position of FIG. 3, the movement part 26 is connected to the bearing part 28 in such a manner that by pulling out or pushing in of the operator control knob 18, and thus of the rotary shaft 17, the movement part 26 is accordingly moved in the bearing part 28, and equally also the bearing part 28 in the housing 12. An upper pressure spring 30 and a lower pressure spring 31 are provided to counteract the axial movements by a force, since there is always one of the two springs compressed. In that context, the pressure springs 30 and 31 advantageously abut the movement part 26 directly and therefor on top near the upper pressure spring 30 said part is to a certain extent wider than within the bearing part 28 and projects beyond it like a collar.

In the lower region, the lower pressure spring 31 is formed with a smaller winding radius at the upper end, and abuts the movement part 26 on a carved region. Indeed, the main function of the pressure springs 30 and 31 is in that the movement part 26 is maintained in a working position as a median position.

Within the shoulder 24 of the housing 12, as visible also in the enlargement D of FIG. 4, an elongate cam part 33 is arranged and displaceable in the longitudinal direction, that is, to the right side. Said part is in the type of a bush and has a rounded cam lobe 34 oriented to the right side. A cam spring 35 is extending in the interior, abutting the end of the shoulder 24 on the left side and urging the cam part 33 to the right. Thus, the interior of the shoulder 24 provides a guidance for the cam part 33.

In the vicinity of the cam part 33, a slider shifting link 37 is provided on the bearing part 28 in the type of a depression. There are two shifting link side walls 38a and 38b including a depression 39 between them, wherein the cam lobe 34 is precisely fitting in the working position. Towards the top the shifting link side wall 38a passes into an abutment flat area 40a. Similarly, the shifting link side wall 38b passes downwards into the abutment flat area 40b. Thus, the slider shifting link 37 is symmetrical to a plane perpendicular to the plane of projection and along the median longitudinal axis of the cam part 33. However, this is not mandatory, since due to an asymmetrical slider shifting link 37 an operator control device may be provided that presents a different sensation according to the direction of operating. The abutment flat areas 40a and 40b give to a user a kind of snap-in sensation for a kind of exact but instable intermediate position that all the same allows further movement to both directions. In this manner, the above mentioned toggling is very well realizable, for example.

As an alternative, it may be provided that pulling out or pushing in of the movement part 26 using the slider shifting link 37 via the operator control knob 18 is detected as such only in case that displacement is to an extent that the cam lobe 34 is located in one of the abutment flat areas 40a and 40b. By means of said clearly perceptible haptic feed-back, an operator is aware what is a specified operation and that it is obtained at present. However, the intermediate positions of the abutment flat areas 40 are instable in that after releasing the operator control knob 18, due to the applied pressure of the cam part 33, the slider shifting link and the movement part 26 and thus also the bearing part 28 slide back into the position as illustrated in FIG. 4. A slider shifting link 37 may also have a configuration differing from those illustrated in FIGS. 3 and 4. However, this is an advantageous practical embodiment, in particular even in relation to the stable intermediate position according to FIG. 4.

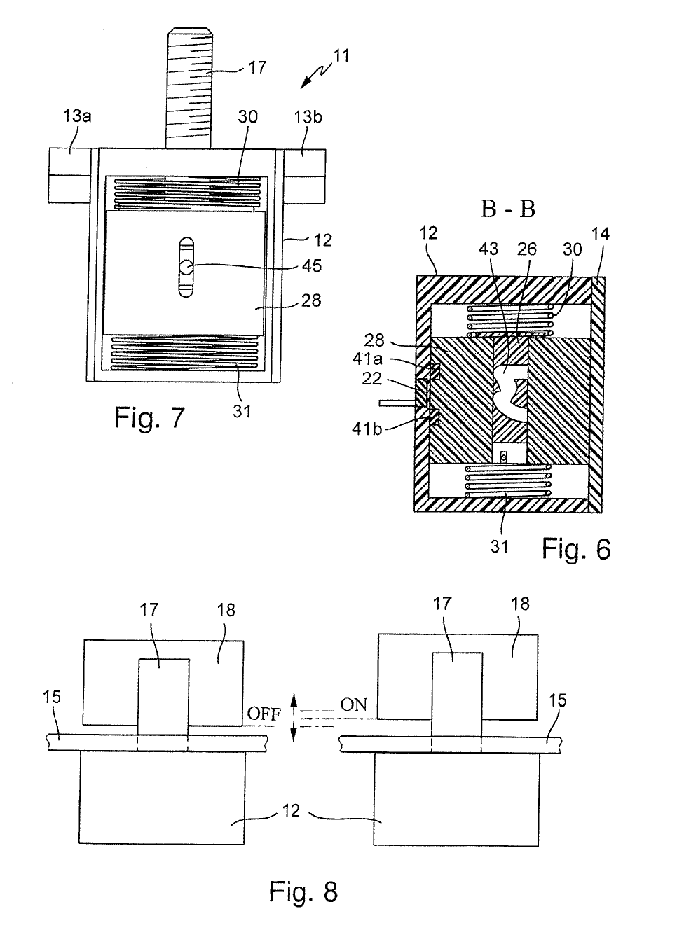

To detect moving of the movement part 26 together with the bearing part 28 via the operator control knob 18 by pushing in and pulling out, the sectional view B-B in FIG. 6 shows that two second signal magnets 41a and 41b can be integrated in the bearing part 28 or be injection molded therein or adhesively bonded thereto similar to the first signal magnet 27. According to FIGS. 1 and 2, the second magnet sensor 22 illustrated therein is also laterally offset adjacent to the first magnet sensor 20, and this applies also to the second signal magnets 41a and 41b. For that reason, they are illustrated in dashed lines in FIG. 1. In the context of the above described figures, it is clearly visible that during pulling out of the operator control knob 18 from the operator control device 11 or away from the control panel 15, the movement part 26 entrains the bearing part 28 due to the positive fitting connection in the working position in said direction. Then, the lower signal magnet 41b is positioned in front of the second magnet sensor 22 by pulling out, the sensor detects it, whereby a corresponding operating signal is generated. The counterforce perceptible for a user at the operator control knob 18 is produced by the upper pressure spring 30 on the one hand, and on the other hand in that the cam part 33 with the cam lobe 34 slides along the lower shifting link side wall 38b and is urged to the left against the cam spring 35. Thus, a counterforce perceptible for a user is produced mainly by the cam part 33 on the slider shifting link 37. When the operator releases the operator control knob 18, the operator control device 11 returns to the position as illustrated in FIGS. 3, 4 and 6. The second magnet sensor 22 can detect this as well, since there is no longer any of the second signal magnets 41a and 41b present in front of it. The same applies to pushing in of the operator control knob 18 into the operator control device 11 or towards the control panel 15.

In that context, FIG. 6 also shows that the magnet sensor 22 is even adapted to measure time, that is, how long any of the signal magnets 41a or 41b is present in front of it. The data may be evaluated for generating various operating signals. Furthermore, the second magnet sensor 22 is arranged to detect, whether or not any of the second signal magnets 41a or 41b is approaching from above or from below or is passing above.

A maximum stop for pulling out from the operator control device 11 is provided by the upper shape of the movement part 26, according to FIG. 3, and namely said part abuts the housing 12 on top. As to pushing in, the operator control knob 18 is the first to abut the top of the control panel 15.

It is desirable for the off position that the movement part 26 is present according to the illustration of FIG. 5, that is with the first signal magnet 27 turned by 90° counterclockwise to the first magnet sensor 20. Here, pulling out or pushing in should not be allowed, what is possibly achieved by lock or catch means (not illustrated) that are generally well-known to those skilled in the art. As an alternative, in fact by means of another device the result should be that in said position the movement part 26 is not connected to the bearing part 28 in positive fitting in the direction of pulling out or pushing in. To that end, the so-called cardioid curve 43, as illustrated in FIG. 6, can be provided as a type of shifting link, wherein a driver 45 supported in the bearing part 28 engages. Said driver is again illustrated in FIG. 3.

In FIG. 8 the off position is illustrated in a side view to the left. Therein, the operator control knob 18 is located relatively close to the control panel 15. Due to the outline of the cardioid curve 43 according to FIG. 6, the operator control knob 18 is then turned by 90° counterclockwise, whereby due to the driver 45 following the cardioid curve 43 the knob somewhat moves away from the control panel 15 to the working position, as illustrated on the right side in FIG. 8. The operator control knob 18 is turned by somewhat more than 90°, for example by 93°, so that upon release it is self-acting to assume the position that is turned exactly by 90°. Therein, the operator control knob 18 is in the above mentioned stable intermediate position, wherein the cam part 33 abuts the depression 39 of the slider shifting link 37 and the driver 45 connects the movement part 26 to the bearing part 28 in the axial direction in a form fitting manner via the cardioid curve 43. Then the operator control knob 18 can be moved by pulling out or pushing in, as described above, and equally move the movement part 26 together with the bearing part 28, and trigger operating signals in response thereto. For example, what may be provided is that a cooktop, or a cooking zone of a cooktop, is to be operated thereby, and namely for power or capacity adjustment. Pulling the operator control knob 18 can cause an increase in power, advantageously in steps. Pushing can accordingly decrease the power. The contingent displacement path may be a few millimeters. Assuming that the illustrations of FIGS. 1 and 2 are about twice as large as an actually employed operator control device, the displacement path during pulling out and pushing in is about two to three millimeters. The force needed to that effect should be relatively small, for example, at maximum 2 Ncm, advantageously somewhat lower.

From the working position, the operator control knob can again be overturned somewhat in the clockwise direction, such that the driver passes again in the cardioid curve. There, the operator control knob is self-acting to return to the off position through the outline of the cardioid curve.

1. An operator control device for functional adjustment of a functional device, comprising an operator control knob, said operator control device being configured such that said operator control knob has an off position, in which said operator control device is deactivated, and that said operator control device can be brought into a working position for functional adjustment, wherein said working position is predetermined by a lock-in position or the like and starting from said working position said operator control knob can be pulled out of said operator control device or pushed into said operator control device against a counter force which increases with increasing distance from said working position, wherein said operator control device includes a movement detection means for detecting movement of said operator control knob from said working position into one direction or the other direction, wherein said movement detection is connected to a control unit of said operator control device for functional adjustment in response to said detected movement.

2. The operator control device according to claim 1, wherein said control unit is configured to effect a more rapid functional adjustment or change upon further movement.

3. The operator control device according to claim 1, wherein by repeated pulling out or pushing in of said operator control knob in the same way with a small movement in the same direction, a functional adjustment like increasing or reducing a capacity adjustment is effected.

4. The operator control device according to claim 1, wherein by repeated pulling out or pushing in of said operator control knob in the same way with a small movement in the same direction, a functional adjustment like increasing or reducing a power adjustment is effected starting from an instable intermediate position of said operator control device.

5. The operator control device according to claim 1, wherein counterforce device for generating said counterforce includes at least one spring, to which an increasing force is applied with increasing movement from said working position to exert said rising counterforce.

6. The operator control device according to claim 5, wherein said counterforce device includes two springs, said two springs being provided in said movement direction, wherein on each end of said operator control device one said spring is provided.

7. The operator control device according to claim 1, wherein a maximum movement length during pulling out said operator control knob from said operator control device or pushing it in is less than 1 cm.

8. The operator control device according to claim 1, wherein a counterforce device for generating a counterforce is configured according to a cam principle, including a protruding cam part extending transversely in relation to said movement, which at least within said working movement region abuts on a slider shifting link for said cam part, said shifting link extending in both movement directions from said working position and essentially consisting of a depression, a deepest point of which forms said working position, wherein said cam part is configured to be pushed in against a spring load transversely to said movement direction of said operator control knob and is spring loaded to abut on said slider shifting link.

9. The operator control device according to claim 8, wherein said cam part is stationary in said pulling direction and in said pushing direction and is movable merely transversely to said movement direction of said operator control knob towards said slider shifting link on said operator control knob.

10. The operator control device according to claim 9, wherein said slider shifting link is symmetrical to a line along said movement direction of said cam part towards said slider shifting link.

11. The operator control device according to claim 1, wherein said counterforce is in the range of about 1 Ncm to 3 Ncm.

12. The operator control device according to claim 1, wherein for detecting a movement of said operator control knob, two magnets disposed successively in said movement direction and a magnet sensor are provided.

13. The operator control device according to claim 12, wherein said magnets are mounted to said operator control knob and said magnet sensor is disposed fixed in location on said operator control device.

14. The operator control device according to claim 13, wherein said magnet sensor is disposed on a housing of said operator control device encasing said operator control knob.

15. The operator control device according to claim 1, being configured for a turn-press actuation, wherein said operator control knob can be turned from the off position and can be pulled out or pushed in not earlier than after turning into said working position.

16. The operator control device according to claim 15, wherein a guidance including a so-called cardioid curve is provided on said operator control knob.

17. An operating method for an operator control device according to claim 1, wherein said operator control device is turned into a working position starting from an off position, wherein, from said working position, it may be pushed into or pulled out of said operator control device, in each case against a counterforce, wherein said movement during pushing in and pulling out is detected, and in response thereto a functional adjustment of a functional device controlled thereby is caused.

18. The operating method according to claim 17, wherein said functional adjustment is effected more rapidly or changes more rapidly the further said operator control knob is moved out of said working position.

19. The operating method according to claim 17, wherein by repeated moving of said operator control knob into or out of said operator control device with very short movements in the same direction, a functional adjustment, like increasing or reducing a power adjustment is effected.

20. The operating method according to claim 19, wherein said functional adjustment is effected starting from an instable intermediate position of said operator control device.

21. The operating method according to claim 19, wherein said short movement is about 1 mm to 3 mm.
